(19) United States
(12) Patent Application Publication
(10) Pub. No.: US 2012/0031644 A1
(43) Pub. Date: Feb. 9, 2012

(54) ULTRACONDUCTING ARTICLES

(75) Inventors: James L. Maxwell, Jemez Springs, NM (US); Chris Randall Rose, Los Alamos, NM (US); Fred Michael Mueller, Los Alamos, NM (US)

(73) Assignee: LOS ALAMOS NATIONAL SECURITY, LLC, Los Alamos, NM (US)

(21) Appl. No.: 13/088,042

(22) Filed: Apr. 15, 2011

Related U.S. Application Data
(60) Provisional application No. 61/324,531, filed on Apr. 15, 2010.

(51) Int. Cl. H01B 5/00; B05D 5/12

(52) U.S. Cl. 174/126.1; 427/105; 977/788

(57) ABSTRACT

Ultraconducting devices and methods of making thereof, said ultraconducting devices comprising continuous, aligned carbon nanotubes and a metallic matrix which substantially surrounds the carbon nanotubes.

### RELATED APPLICATION

This patent claims priority from U.S. Provisional Application Ser. No. 61/324,531 entitled “Ultraconducting Articles” and filed on Apr. 15, 2010. U.S. Provisional Application Ser. No. 61/324,531 is hereby incorporated by reference in its entirety.

### STATEMENT OF FEDERAL RIGHTS

The United States government has rights in this invention pursuant to Contract No. DE-AC52-06NA25396 between the United States Department of Energy and Los Alamos National Security, LLC for the operation of Los Alamos National Laboratory.

### FIELD OF THE INVENTION

The present invention relates to ultraconducting articles comprising continuous, aligned carbon and inorganic nanotubes, and to methods of making thereof.

### BACKGROUND OF THE INVENTION

Most transmission lines and power conductors currently are based on copper and aluminum alloys, and molten metals are extruded or drawn to create wire. Some alternative technologies include superconductor tapes, polymer film growth, polymer encapsulation of nanomaterials, and powder-in-tube superconductors. Whereas metals have advantages of good electrical conductivity, are malleable, relatively low cost, and are easily drawn and formed, they have limited tensile strength. In fact, some transmission applications require cable of such lengths that the metal conductor cannot hold its own weight without stretching and deforming. Superconductors, on the other hand, offer no-loss DC power transmission, but have high cost, brittleness, are more difficult to form, are subject to both critical current and magnetic quench, and require continuous cryogenic cooling.

A need exists, therefore, for a new electrical conductor which has conductivity much greater than that of common metallic conductors, is cost effective, has a tensile strength better than steel or graphite fibers, can be easily formed, and should not be subject to current density, magnetic field or temperature quench.

Carbon nanotubes (CNTs) offer a possible means of meeting the aforementioned needs. Carbon nanotubes (CNTs) may be thought of as cylindrical sheets of graphene or extended hexagonal arrays of sp²-hybridized carbon with a conjugated π-system. The sidewalls are arranged in a helical fashion around the tube axis and may be considered single-dimensional objects due to the small outer diameters (nm) and high length-to-width aspect ratio (typically greater than 100).

Individual CNTs are extremely tiny (soda-straw-like) so that it takes a bundle of over 370 million of them to make a metal/CNT composite with the size and diameter of a single human hair. Single CNTs exhibit a number of interesting properties, namely: 1) a tensile strength of 63 GPa, or about 50 times that of piano wire; 2) a thermal conductivity of about 3500 W m⁻¹ K⁻¹ or about nine times more than that of diamond; 3) a density of 1.3 g/cm³, which is lower than that of commercial carbon fibers (1.8-1.9 g/cm³) and 4) an electrical conductivity which is 1200 times that of excellent copper metal. CNTs also have a high stiffness to weight ratio, with a Young's modulus about five times higher than that of carbon fibers.

CNTs also have interesting electrical properties and can range from highly conductive metals to semiconductors with a large band gap. The chirality of the nanotube, or twist, which is described by how a conceptual graphene sheet would be rolled to form the tube, determines whether the CNT behaves as a metal or semiconductor. Metallic CNTs have ballistic transport, meaning there is zero resistance along the tube, and thus can have conductivities 1200 times higher than copper. Because of their very low energy dissipation, CNTs can carry approximately 10,000 times greater current densities than superconducting wires.

The most commonly used method of making CNTs is chemical vapor deposition, or CVD. This process involves the decomposition of an organic gas over a substrate covered with metal catalyst particles. This technique is usually preferred because it is scalable and the CNTs produced may be used directly without further purification, unless the final material requires catalyst particle removal. Based on the reaction conditions and/or catalyst used, CNTs can be synthesized as multi-walled carbon nanotubes (MWCNTs, 5-100 nm diameter) which are composed of several tubes lying within one another concentrically, or as single-walled carbon nanotubes (SWCNTs, 1-3 nm diameter) Other methods for producing CNTs include the electric-arc discharge and laser vaporization.

It is clear, however, that in order to make practical use of these properties, a number of challenges must be met, including not only making these materials in quantities of quadrillions (10¹⁵ CNTs), but also aligning, embedding, and for safety reasons, enclosing or encapsulating the CNTs in a protective layer or membrane. For production of CNT-containing cable and wires, position-controlled, uniform, dense and aligned nanotubes are desired. Vertically aligned CNTs have been grown using plasma and thermal CVD techniques. A disadvantage of these techniques is that pre-patterning of the catalyst is a necessary step for obtaining position-controlled growth. It has also been reported that amorphous carbon is deposited over the catalyst-free regions of the substrate, which may cause problems in post-processing and practical use of the product. A few examples have also been reported of laser-catalyzed CVD growth of CNTs, but most were not vertically aligned and only short lengths (<60 μm) were able to be obtained.

A further need exists, therefore, for CNTs in a form which are suitable for practical applications, including sufficient quantity, length, alignment and embedding, and for efficient and relatively inexpensive methods of making thereof.

### SUMMARY OF THE INVENTION

The present invention meets the aforementioned needs by describing a novel method of manufacturing long-length (continuous) carbon and inorganic nanotubes, while simultaneously embedding the nanotubes in a metallic matrix, to form a continuous CNT composite material, or “ultraconductor.” The ultraconductor of the present invention can be easily formed into required shapes, such as wires or stranded cables, and allows greatly enhanced conductivity over existing metallic conductors. Additionally, the ultraconductor of the present invention is more cost effective than copper-alloy conductors and simultaneously minimizes the use of expensive or rare materials.

The method of making the ultraconductor of the present invention enables the growth of very long length-metallic nanotubes, such as CNTs, while simultaneously cladding them within a metal matrix. By embedding CNTs in a metal matrix, ballistic transport occurs within the nanotubes, thus increasing the net electrical conductivity of the metal matrix. This nanocomposite material accretes the benefits of both the CNTs and the metal, providing both increased conductivity and structural strength.

The method of the present invention for the first time produces CNT composite materials in a single step. The method of the present invention simultaneously grows long length CNTs, aligns, clads, embeds, and encapsulates the CNTs into a CNT/metal composite matrix. This matrix is of the same size, shape, and appearance of ordinary copper wire, but it has a fine structure of CNT which makes the electrical conductivity of the composite many times higher than that of copper alone. This matrix also has greater strength and higher thermal conductivity. This close similarity to traditional copper wires allows the continuous CNTs of the present invention to easily replace ordinary copper wires, in cables, and in other applications easing and accelerating their use without the need for substantial redesigns or re-engineering.

The ultraconductors and methods of the present invention offer a number of advantages. First, this is the only process to date that allows for continuous nanotube growth for ballistic transport over very long distances. Being a continuous-growth process, the method of the present invention allows for very long nanotubes and cable lengths to be created. Second, the cost per ampere is significantly less than that of copper. Third, the method of the present invention has the ability to create stronger wires, filaments and cables due to its high tensile strength. In contrast, previous methods rely on low strength plastics mounted on some type of substrate, or on polymer encapsulation, neither of which is as strong and electrically robust as metallic clad CNTs. Fourth, the ultraconductors of the present invention have a greater ability to dissipate heat at high-current and temperatures. Through the use of a metal matrix (as opposed to a polymer film or encapsulation), hot spots are reduced in the conductor, and heat can be efficiently dissipated. In fact, the polymer film growth method does not use CNTs, but relies on hyperconducting properties of plastic films. Fifth, the method of the present invention is simple, in that carbon nanotubes are may be aligned and encapsulated in one continuous process. Sixth, the ultraconductors of the present invention have the ability to operate without cooling at room temperature and work well even at elevated temperatures. In addition, as the electrical conductivity of the CNTs increases with temperature, temperature feedback is eliminated that can ordinarily create hot-spots and damage traditional conductors. Very high operating temperatures of up to 500° C. are possible, allowing for carrying of very large currents without damage. Finally, the ultraconductors of the present invention can be used just as traditional cabling for devices and in flexible applications. Hybrid nanocomposites of the ultraconductors of the present invention can be bent to tight radii, and will act very similar to traditional metallic conductors in applications such as windings, transformers, etc. In contrast, superconductive tapes have limited flexibility for such applications, and are easily damaged.

The ultraconductors of the present invention have a number of applications, including but not limited to use in high-voltage cables used to transmit power to homes and businesses; use in motors and generators that power everything from simple electronics to complex manufacturing systems; for use as electrical wires used in everything from simple electronic devices such as cell phones and televisions to specialized applications in which the tensile strength of copper or aluminum conductors are insufficient; use in magnetic storage devices that allow the use of alternative energy sources requiring enhanced grid stability and using wind, solar, or other intermittent energy sources; use in micro- and nanoscale waveguides and other communication structures for terahertz- and millimeter-wave applications; and use in position- and pressure-activated sensors in which the conductivity of the string changes with position or pressure.

### BRIEF DESCRIPTION OF THE DRAWINGS

FIG. 1 depicts the temperature-dependent electrical conductivity of the ultraconductors of the present invention (upper curve) vs. copper (lower curve) over a useful operating range (300 Kelvin is room temperature).

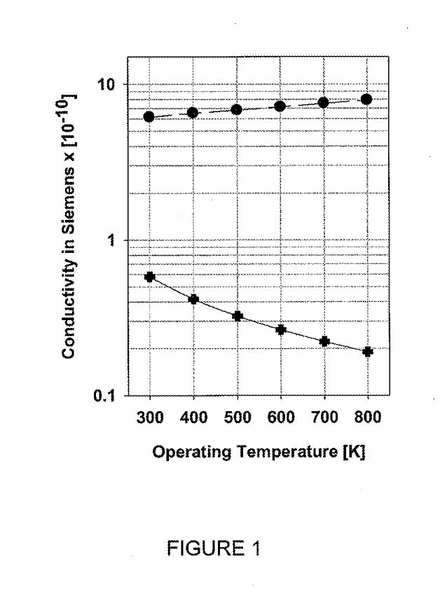

FIG. 2 depicts one embodiment of the present invention. The aligned carbon nanotubes are about 10 nm in diameter. The tubes are embedded in a metal cladding ensuring conduction horizontally between tubes. There is very little resistance along their length, i.e., they are ballistic or quantum conductors.

FIG. 3 (A) depicts bundles of vertically aligned nanotubes, grown selectively from a substrate using catalytic nanoparticles. Note that each “pixel” contains roughly 370 million nanotubes in a cross-sectional area of only 25×25 microns; (B) Growth of aligned CNTs along the length of a wire using the method of the present invention. Observe the catalyst nanoparticles at the tips of the individual CNTs. The aligned nanotubes are subsequently coated with metals and/or metal alloys; (C) Shows metal-coated nanotubes through a break in the surface encapsulation. This process is repeated to sequentially create many layers of aligned and coated nanotubes to the desired ultraconductor diameter.

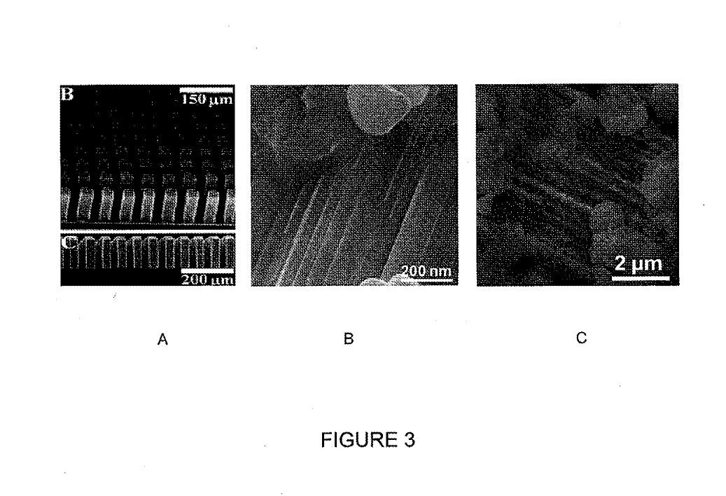

FIG. 4 depicts ultraconductor branching without the need for connectors or terminals.

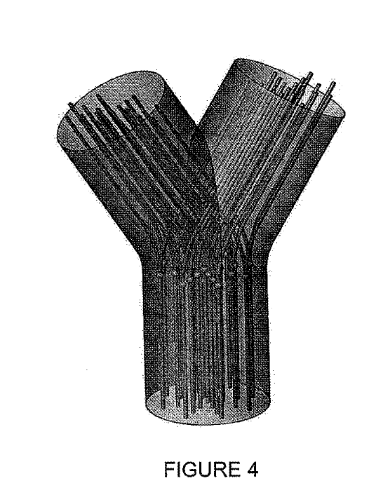

FIG. 5 depicts the process sequence used to make the ultraconductors of the present invention.

### DETAILED DESCRIPTION OF THE INVENTION

The method of the present invention allows for the growth of very long metallic nanotubes, such as carbon nanotubes (CNTs), while simultaneously cladding them within a metal matrix. By embedding CNTs in a metal matrix, ballistic transport occurs within the nanotubes, thus increasing the net electrical conductivity of the metal matrix.

The conductance of a metallic CNT is independent of the length. Unlike traditional metal wires in which their conductance is inversely proportional to the wire length (i.e., G=A/pL), the quantum conductivity of carbon nanotubes is G=2e²/h, where e is the fundamental charge of an electron and h is Planck's constant. Note that there is no length specified in the CNT equation, one representing an ideal case of a perfect CNT with one end. In such cases, there are only two states: (1) the metallic CNT conducts this value or (2) the metallic CNT is nonconducting. Hence, a CNT can act as an ideal conduit for electrons.

The difficulties with using CNTs to make an ultraconductor are fourfold: (1) there must be a route through which electrons can enter and leave the nanotube's conductive path, (2) there must be a means for electrical conduction from nanotube-to-nanotube within the bundle, (3) it must be possible to make long and continuous nanotubes, and (4) and sufficiently high percentages of metallic nanotubes must be created.

The method of the present invention resolves all four issues, and utilizes defects found in the CNTs. These defects/impurities can serve as routes through which electrons can enter and leave a nanotube's conductive path. A common defect in carbon nanotubes is a “diode,” in which a pair of structures exist side by side, one with a five-member ring (the “n” material) and the other with a seven-member ring (the “p” material). During synthesis, these diodes can be created through mismatches and damages to the lattice. Moreover, impurities and missing atoms from the lattice also provide routes of entry and egress from the quantum conductor. Carbon nanotubes are also somewhat unique in that they can be readily doped with boron and nitrogen, thus providing stable n- and p-type diode materials for entry and egress. Thus, in the present invention, the carbon nanotubes are doped or alloyed with boron and nitrogen to improve their conductivity. The method of the present invention creates conductive paths in/out of the CNTs, as well as paths between the nanotubes, by appropriately doping the CNTs, coating lightly with proprietary metals, and then embedding the CNTs in a metallic matrix.

As shown in below in TABLE 1, the ultraconductors of the present invention are a significant improvement on the competitive technologies currently available.

TABLE 1
COMPARISON MATRIX

| | | Polymer Film | Polymer | | |
|---|---|---|---|---|---|
| | | Growth and | Encapsulation of | Wire | Superconductors |
| Parameters | Ultraconductors | Manufacturing | Nanotubes | Drawing/Pulling | and Tapes |
| Achieves | Yes | Limited | Limited | No | Yes |
| Ultrahigh | | | | | |
| Conductivity over | | | | | |
| Long Conductor | | | | | |
| Lengths | | | | | |
| Reduces | Yes | Limited | Limited | No | No |
| Costs/Ampere | | | | | |
| over Existing | | | | | |
| Copper or | | | | | |
| Aluminum Alloys | | | | | |
| Creates High- | Yes | No | Limited | Limited | No |
| strength and | | | | | |
| Flexible Cables | | | | | |
| Dissipates Heat at | Yes | Limited | Limited | Limited | Yes |
| High Current and | | | | | |
| Temperature | | | | | |
| Simple | Yes | No | No | No | No |
| Manufacturing | | | | | |
| Process | | | | | |
| Operates without | Yes | Limited | Limited | Yes | No |
| Cooling at Room | | | | | |
| Temperature and | | | | | |
| at Elevate | | | | | |
| Temperatures | | | | | |
| Greater than | | | | | |
| 300° C. | | | | | |
| Produces Long | Yes | Limited (Yes with | No | Yes | Limited |
| Lengths of Aligned | | respect to | | | |
| Nanotubes at | | effective | | | |
| Effective | | production rates) | | | |
| Production Rates | | | | | |
| Can be Used for | Yes | Limited | Limited | Yes | No |
| Electrical Devices, | | | | | |
| Power | | | | | |
| Transmission, and | | | | | |
| as Traditional | | | | | |
| Cabling | | | | | |
| Can be Used for | Yes | No | No | No | No |
| New Applications, | | | | | |
| such as Grid-wide | | | | | |
| Energy Storage | | | | | |
| and Micro/Nano | | | | | |
| Filters for | | | | | |
| Biological and | | | | | |
| Sensor Devices | | | | | |

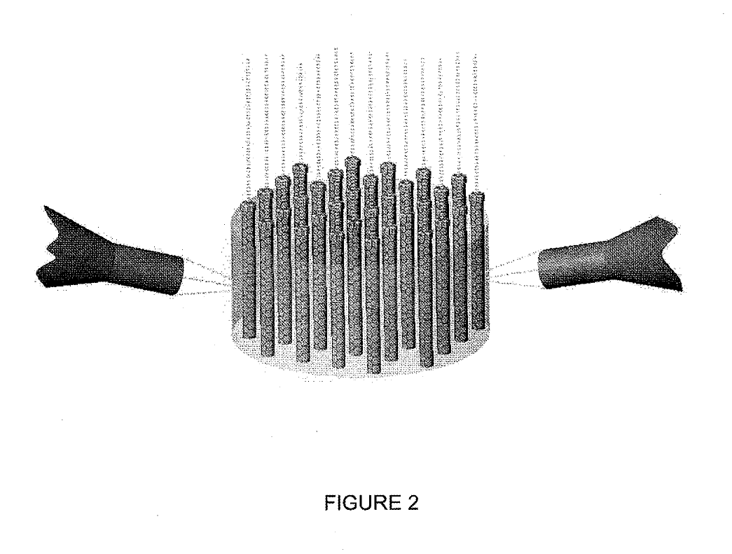

To fabricate long conductive nanotubes in a matrix, the method of the present invention employs laser-induced chemical reactions and selective chemistry to first form nanotubes and then physically and chemically infiltrates a metal matrix between the tubes. As illustrated in FIG. 2, the method begins when a primary set of laser beams is focused on a pressurized chamber containing a retractable mandrel coated with catalytic nanoparticles. Hydrogen and an appropriate hydrocarbon, for example methane, acetylene, and other suitable hydrocarbons, then flow through a nozzle onto the laser foci where vertically aligned carbon nanotubes are grown into the laser beams. If the beams remain stationary, CNTs will grow into their respective beams along the laser axis. When the focused laser spots are drawn backward, the CNTs follow, thus yielding long strands of material. In each laser focus there are millions of CNT strands.

Once the strands reach critical length, a second set of laser beams is focused near the lower end of the bundles while simultaneously flowing trace quantities of metallic precursor gases across these laser foci. Suitable metallic precursors include gold, silver, platinum, other noble metals, alloys thereof, compounds thereof, and combinations of any of the foregoing. A chemical reaction occurs at this second set of foci, resulting in the formation of a metal matrix in between the nanotube strands. This two-step process then continues onward, as the newly formed nanocomposite wires are drawn backward and spooled outside the chamber through a vapor trap. In alternative embodiments, the CNT bundles are heated through other means (inducing a selective chemical reaction) or are coated through physical means, such as capillary action and solidification.

In another embodiment, the method of the present invention is used to grow wires, after which the wires are spray coated with catalytic nanoparticles. A second set of laser beams is focused onto the side of these wires, while introducing a precursor gas for carbon-based or inorganic nanotubes. A magnetic, electric, or acoustical field is applied to the resulting tethered nanotubes that grow off the wire, such that the nanotubes line-up with the axis of the wire. A flow of precursor gas can also be used to align the nanotubes. The nanotubes are then coated with a metal, such as gold, silver, platinum, other noble metals, and combinations or alloys thereof. An additional metal can be applied, if desired. It is important to note that, to ensure maximal conductivity, the metal and/or alloys are deposited in a 4⁺ oxidation state at the nanotube surface which, at the imperfections (diodes) in the carbon nanotubes, changes the potential such that electrons are transported from the diodes to the metals. These coatings can be laser deposited, or applied by another method such as PLD, CVD, or PVD. The process can be repeated as many times as necessary, to build up a required number of nanotubes. This process can be made into a sequential automated system, with wire passing through sequential processing stations.

In an alternative embodiment, the carbon nanotubes also may be coated with a suitable polymer as a means to exploit their ballistic conductivity characteristics. To gain full advantage of ballistic characteristics, the CNTs must be aligned such that electrical current can travel along their lengths, jumping as necessary from CNT to CNT. Although it is extremely easy for current to travel along their length, it is more difficult for current to jump from side to side.

Examples of Fabrication Method Implemented

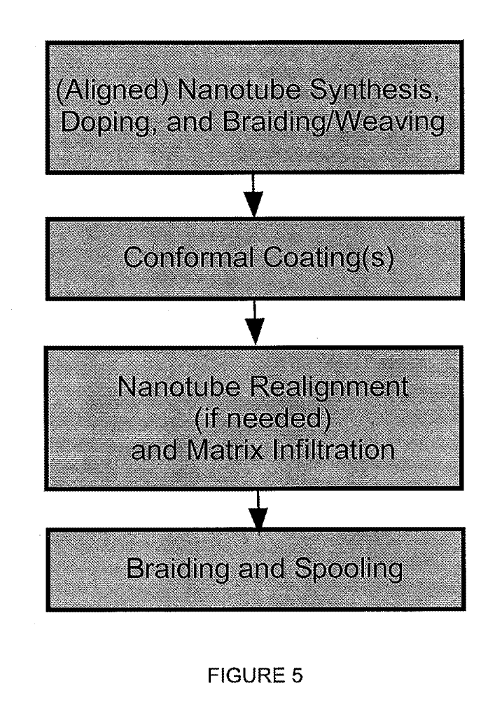

As discussed above the ultraconductor of the can be fabricated in many different ways. However, they all have a common fabrication sequence, shown in FIG. 5. First, one must grow well-aligned nanotubes, in a manner that they can be continuously generated, not just as short, batch-grown nanotubes. Then they must be coated continuously and conformally with a very thin layer (e.g. <10 nm) of a metal, alloy, or conductive complex that ensures good electrical contact with the entire surface of the nanotubes, whether they are interior to the bundle or at the outside of the bundle. Next, the coated nanotubes must be carried into a third process that allows a less expensive, matrix metal to fill the gaps between the nanotubes and create a solid (nanocomposite) wire strand. Of course, many of these strands can be created at once to form a bundled or braided cable. Many metals may be used for either coating or for the metal matrix. For example for the coatings any of the following may be used: Pt, Pd, Au, Rh, Ru, Ag, Al, Cd, Cr, Cu, Ni, Mg, or Ti, and additionally any alloys of these, e.g.: Pt—Ir, Pt—Ru, Pt—Pd—Ru, Pd—Ru, Pd—Cu, Pd—Ag, Pd—Pt—Au-Ag, Pd—Ag—Ni, Pd—Ag—Cu—Au—Pt—Zn, Pd—Ag—Cu—Pt—Zn, Au—Ni, Au—Pt, Au—Ag, Au—Pt—Cu, Au—Cu, Au—Cu—Pt—Ag—Zn, Ag—Pt, Ag—Au, Ag—Pa, Ag—Mg—Ni, Ag—Mg, Cu—Zn, Cu—Cd, or Cu—Sn. For the matrix metals any of the following maybe used: Cu, Al, or Ag or any alloys of these e.g.: Cu—Ag, Cu—Cr, Cu—Cr—Zr, CuBe, or Al—Si.

In one example, to grow continuous carbon nanotubes, iron-cobalt nanoparticles were used as catalysts, pre-arranged on an initial substrate. (Ideally, these catalysts are pre-selected for size and crystal orientation.) Chemical vapor deposition precursors were then applied through a nozzle directed at and around the growth zone. These precursors could contain, not just a precursor for carbon nanotubes, but also a precursor for a dopant, such as boron, to change the electrical characteristics of the nanotubes, so that better connections can be made to/from the nanotube. A laser beam was then broadly focused onto at least one such growth zone, to heat the catalysts to the point that nanotubes grew from the catalyst. Typically, the carbon nanotubes grew away from the substrate, with the catalyst riding the tip of the growing nanotube. This tended to result in aligned nanotubes of similar size growing into the laser beam. However, three modifications to this approach assisted in creating more highly-aligned nanotubes. First, application of a strong magnetic field (e.g. at one end of a solenoid), pulled the catalyst particles in a common direction. Second, application of an electrostatic field between the nanotube catalysts and an opposing electrode assisted not only with alignment, but can also be used to enhance the growth rate. Third, by directing the flowing gas from behind the initial substrate, the gas flow tended to align the nanotubes in a common direction. This directionality, regardless of the method(s) used to achieve it, is important for performance of the ultraconductors of the present invention, as the more highly-aligned the nanotubes, the better the overall electrical conductivity. Finally, it should be noted, that it is not absolutely necessary to have an initial substrate to start the growth, as nanotubes initiated on particles that were simply suspended in the flowing gas. In fact, at/near supercritical fluid precursor pressures, nanotubes could be created at extremely high rates (g/s).

Next, it is necessary to coat the nanotubes conformally. In one implementation, laser-grown carbon nanotubes were coated by reheating them with a high-power laser at right angles to the first, and flowing a gold CVD precursor (Gold Acetylacetonate) through the nanotube bundles behind the original carbon nanotube growth region. This formed a gold coating over the newly-formed carbon nanotubes, creating electrical contacts with nanotube junctions and terminations. Note, however, that many different processes for performing this operation are possible, including microwave/RF heating of the nanotubes, plasma chemical vapor deposition (PE-CVD), magnetron and high-power impulse sputtering, pulsed laser deposition (PLD), and electroplating. The key is to obtain a conformal coating over all the nanotubes, where the coating is in intimate contact with the entire surface of the nanotubes. This coating should not just be loosely adhered or just islands of coating material, but should be continuous. This ensures a good electrical contact from the nanotubes to the surface coating, and to the matrix material to be added later. In a second implementation, we used electroplating of copper to obtain copper coatings on carbon nanotubes. In a third implementation, we used thermal evaporation physical vapor deposition (PVD) to coat carbon nanotubes on all sides with platinum, palladium, or gold.

After coating the nanotubes, a matrix of conductive material, such as a metal, is added to the space between the coated nanotubes to ensure electrical contact between nanotubes in the bundle. This can be implemented in several ways. In one implementation chemical vapor deposition of gold were used to perform this task, while laser heating the bundle of nanotubes. Additionally coated nanotubes were placed in liquid metals (e.g. gallium), which could be cooled to form a solid nanocomposite wire. However, there are many ways in which this task can be accomplished, including: microwave CVD, high-pressure electroplating (to remove gases between nanotubes by condensation of metal vapors onto the nanotube bundles).

### Example 1

### Results

In the copper matrix, gold-coated nanotube samples, electrical conductivity improvements of over 5% over bulk copper were measured. In the gallium matrix samples, electrical conductivity increases of up to 20% over bulk gallium, even without coating the nanotubes, was observed.

An additional approach mixes the coated nanotubes (not necessarily pre-aligned), into a liquid metal bath, concentrates the nanotubes using density differences, and drives the mix of nanotubes and liquid metal through a specialized die. As it passes through the die the mix is cooled and solidified into a wire. This has the particular advantage that the nanotubes can be aligned due to the nature of the fluid flow (e.g. through shear forces). After the matrix is formed for each bundle, multiple bundles can be braided or combined into larger cables.

Whereas particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An ultraconductor comprising:
a. a plurality of aligned, continuous carbon nanotubes coated with a conductive complex, wherein there are spaces between the carbon nantubes; and
b. a matrix of conductive material added to the spaces between the coated carbon nanotubes.

2. The ultraconductor of claim 1 wherein the carbon nanotubes are coated with a metal or an alloy.

3. The ultraconductor of claim 2 wherein the metal or alloy is one of the following: Pt, Pd, Au, Rh, Ru, Ag, Al, Cd, Cr, Cu, Ni, Mg, Ti, Pt—Ir, Pt—Ru, Pt—Pd—Ru, Pd—Ru, Pd—Cu, Pd—Ag, Pd—Pt—Au-Ag, Pd—Ag—Ni, Pd—Ag—Cu—Au—Pt—Zn, Pd—Ag—Cu—Pt—Zn, Au—Ni, Au—Pt, Au—Ag, Au—Pt—Cu, Au—Cu, Au—Cu—Pt—Ag—Zn, Ag—Pt, Ag—Au, Ag—Pa, Ag—Mg—Ni, Ag—Mg, Cu—Zn, Cu—Cd, or Cu—Sn.

4. The ultraconductor of claim 1 wherein the matrix of conductive material is a metal or an alloy.

5. The ultraconductor of claim 4 wherein the metal or alloy is one the following: Cu, Al, Ag, Cu—Ag, Cu—Cr, Cu—Cr—Zr, CuBe, or Al—Si.

6. The ultraconductor of claim 1 wherein the carbon nanotubes and matrix combine to form solid wire strands.

7. The ultraconductor of claim 6 wherein the solid wire strands may form a bundled or braided cable.

8. A method of making an ultraconductor comprising:
a. fabricating aligned, continuous carbon nanotubes;
b. coating the carbon nanotubes with a conductive complex; and
c. adding a matrix of conductive material to spaces created between the carbon nanotubes.

9. The method of claim 8, further comprising realigning the carbon nanotubes.

10. The method of claim 8, further comprising applying chemical vapor precursors in order to change the electrical characteristics of the carbon nanotubes.

11. The method of claim 8 wherein the coating is applied conformally.

12. The method of 8 wherein the coating is applied by one of the following methods: reheating the carbon nanotubes with a high-power laser at right angles to the first, and flowing a precursor through the carbon nanotubes, microwave/RF heating of the carbon nanotubes, plasma chemical vapor deposition, magnetron and high-power impulse sputtering, pulsed laser deposition, or electroplating.

13. The method of claim 8, wherein the coating is a metal or an alloy.

14. The method of claim 13 wherein the metal or alloy is one of the following: Pt, Pd, Au, Rh, Ru, Ag, Al, Cd, Cr, Cu, Ni, Mg, Ti, Pt—Ir, Pt—Ru, Pt—Pd—Ru, Pd—Ru, Pd—Cu, Pd—Ag, Pd—Pt—Au-Ag, Pd—Ag—Ni, Pd—Ag—Cu—Au—Pt—Zn, Pd—Ag—Cu—Pt—Zn, Au—Ni, Au—Pt, Au—Ag, Au—Pt—Cu, Au—Cu, Au—Cu—Pt—Ag—Zn, Ag—Pt, Ag—Au, Ag—Pa, Ag—Mg—Ni, Ag—Mg, Cu—Zn, Cu—Cd, or Cu—Sn.

15. The method of claim 8 wherein the adding a matrix is done by one of the following methods: chemical vapor deposition while laser heating the nanotubes, placing the coated nanotubes in liquid metals, microwave chemical vapor deposition, or high-pressure electroplating.

16. The method of claim 8 wherein the matrix of conductive material is a metal or an alloy.

17. The method of claim 16 wherein the metal or alloy is one the following: Cu, Al, Ag, Cu—Ag, Cu—Cr, Cu—Cr—Zr, CuBe, or Al—Si.

18. A method of making an ultraconductor comprising:
a. fabricating continuous carbon nanotubes;
b. coating the carbon nanotubes with a conductive complex;
c. mixing the coated carbon nanotubes into a liquid metal bath;
d. concentrating the carbon nanotubes using density differences; and
e. driving the mix of carbon nanotubes and liquid metal through a specialized die.

19. The method of claim 18, further comprising the step of cooling the carbon nanotubes and liquid metal as it passes through the die so that it solidifies into a wire.

20. The method of claim 19 wherein the liquid metal bath is gallium.
